(19) United States
(12) Patent Application Publication
(10) Pub. No.: US 2024/0144902 A1
(43) Pub. Date: May 2, 2024

(54) MUSICAL INSTRUMENT, METHOD OF FORMING SOUND EMITTING OPENING FOR MUSICAL INSTRUMENT, AND REINFORCING MEMBER

(71) Applicant: YAMAHA CORPORATION, Hamamatsu-shi (JP)

(72) Inventors: Masao SATO, Hamamatsu-shi (JP); Takayuki OHGO, Hamamatsu-shi (JP)

(21) Appl. No.: 18/404,088

(22) Filed: Jan. 4, 2024

Related U.S. Application Data
(63) Continuation of application No. PCT/JP22/27106, filed on Jul. 8, 2022.

(30) Foreign Application Priority Data
Jul. 9, 2021 (JP) 2021-114192

(51) Int. Cl. G10H 1/32

(52) U.S. Cl. CPC G10H 1/32

(57) ABSTRACT

A musical instrument includes: a housing including a first opening; and a reinforcing member that reinforces the housing and including a second opening overlapping with the first opening. The second opening allows emission of sound generated in an interior of the housing to outside of the housing therethrough.

### CROSS-REFERENCE TO RELATED APPLICATIONS

The present application is a continuation application of International Application No. PCT/JP2022/027106, filed Jul. 8, 2022, which claims priority to Japanese Patent Application No. 2021-114192, filed Jul. 9, 2021. The contents of these applications are incorporated herein by reference.

### BACKGROUND

### Technical Field

The present disclosure relates to a musical instrument, a method of forming a sound emitting opening for a musical instrument, and a reinforcing member.

### Background Art

A musical instrument such as an electronic organ or an electronic piano have a sound source such as a speaker in the interior of the housing thereof. In this type of musical instrument, sound is generated from the sound source in response to the operation (for example, key operation) performed on the musical instrument by the performer, and the sound is emitted to the outside of the housing. Japanese Unexamined Patent Application, First Publication No. 2005-202081 (hereinafter Patent Document 1) discloses a musical instrument in which a sound emitting opening (tone-escaping part) is formed in a member forming the upper face of the housing. Japanese Unexamined Patent Application, First Publication No. H01-321479 (hereinafter Patent Document 2) discloses a keyboard instrument that uses a gap in the keyboard as a sound emitting opening (tone-escaping part). As disclosed in Patent Documents 1 and 2, by providing a sound emitting opening, the sound generated by the sound source is emitted from the housing in various directions, allowing the performer and the audience to enjoy rich and powerful performance sounds.

### SUMMARY OF THE INVENTION

In conventional musical instruments, a reinforcing member that reinforces the housing by, for example, joining members of the housing together may hinder sound emission from the inside of the housing to the outside. For this reason, in conventional musical instruments, the sound generated by the sound source inside the housing is not effectively utilized, and there is room for improvement in order to entertain the performer and audience with sufficiently rich and powerful performance sounds.

The present disclosure has been made in view of the circumstances described above. An example of an object of the present invention is to provide a musical instrument and a method of forming a sound emitting opening for a musical instrument capable of effectively utilizing the sound generated in the interior of the housing of a musical instrument to thereby enable the performer and the audience to enjoy rich and powerful performance sounds.

A first aspect of the present disclosure is a musical instrument including: a housing including a first opening; and a reinforcing member that reinforces the housing and including a second opening overlapping with the first opening. The second opening allows emission of sound generated in an interior of the housing to outside of the housing therethrough.

A second aspect of the present disclosure is a method of forming a sound emitting opening for a musical instrument. The method includes: providing a housing that includes a first opening; providing a reinforcing member including a second opening for reinforcing the housing; and attaching the reinforcing member to the housing so that the second opening overlaps with the first opening to allow emission of sound generated in an interior of the housing to outside of the housing.

A third aspect of the present disclosure is a reinforcing member for a musical instrument including a housing with a first opening. The reinforcing member includes: a member including a second opening and that reinforces the housing. The second opening is disposed overlapping with the first opening to permit emission of sound generated in an interior of the housing to outside of the housing.

### BRIEF DESCRIPTION OF THE DRAWINGS

FIG. 1 is a plan view showing a musical instrument according to an embodiment of the present disclosure.

FIG. 2 is a rear view of the musical instrument of FIG. 1 as viewed from the II direction.

FIG. 3 is a cross-sectional view along the arrows of FIG. 1, 2.

FIG. 4 is an enlarged cross-sectional view showing a main part of FIG. 3.

FIG. 5 is a perspective view of a structure of the musical instrument of FIG. 1 to FIG. 4, in which a top board and a back board of a housing are joined together by a joining member, viewed from the inside of the housing.

FIG. 6 is an exploded perspective view showing a state in which the joining member and a cover member are removed from the top board and the back board in the structure of FIG. 5.

FIG. 7 is an exploded perspective view showing a state in which the top board and the back board are separated from each other in the structure of FIG. 6.

### DETAILED DESCRIPTION OF THE EMBODIMENTS

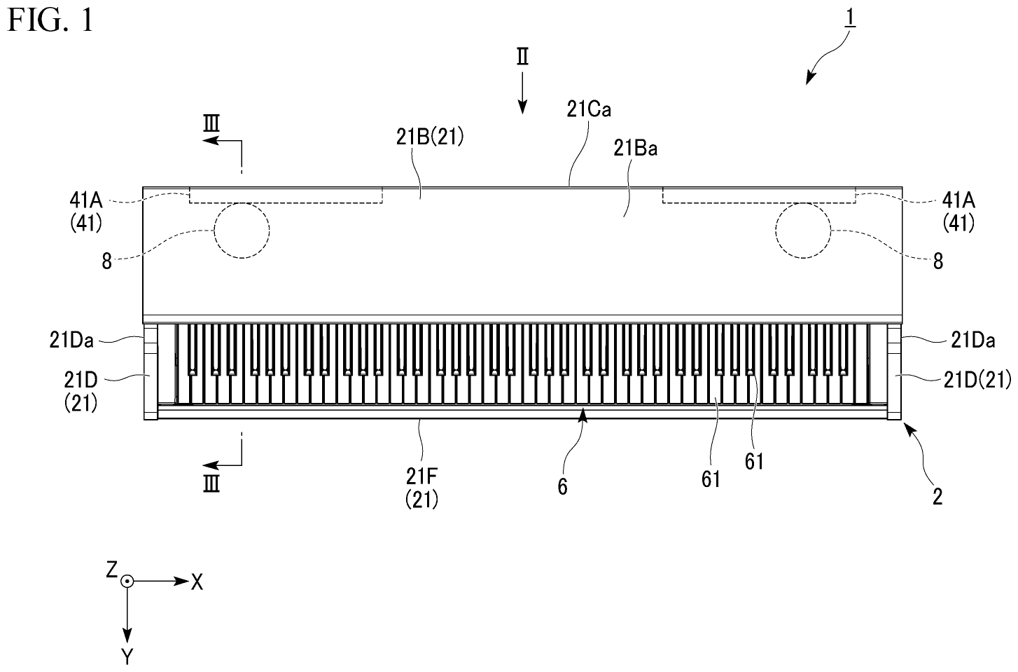

Hereinafter, an embodiment of the present disclosure will be described, with reference to FIG. 1 to FIG. 7.

As shown in FIG. 1 to FIG. 3, a musical instrument 1 includes a housing 2 and reinforcing members (members) 41. The musical instrument 1 of the present embodiment further includes a keyboard part 6, a keyboard lid 7, and speakers 8 (sound sources). The keyboard part 6 is configured by arranging a plurality of keys 61 in one direction (X-axis direction). The musical instrument 1 of the present embodiment may be, for example, a synthesizer that uses electronic circuits to generate various sounds.

In the following description, the Z-axis direction in the drawings may be referred to as up-down direction. Also, in some cases, the Z-axis positive direction in the drawings may be referred to as upward direction, and the Z-axis negative direction as downward direction. Further, in some cases, the direction perpendicular to the up-down direction and in which the plurality of keys 61 are arranged (X-axis direction) may be referred to as left-right direction, and the direction perpendicular to the vertical and horizontal directions (Y-axis direction) as front-rear direction. Also, in some cases, the Y-axis positive direction in the drawings may be referred to as forward direction, and the Y-axis negative direction as backward direction.

The housing 2 has a space S in the interior thereof (hereinafter, referred to as internal space S). The housing 2 has a plurality of members 21. In the present embodiment, the plurality of members 21 include a bottom board 21A, a top board 21B (first member), a back board 21C (second member), side boards 21D, a front top board 21E, and a key slip 21F.

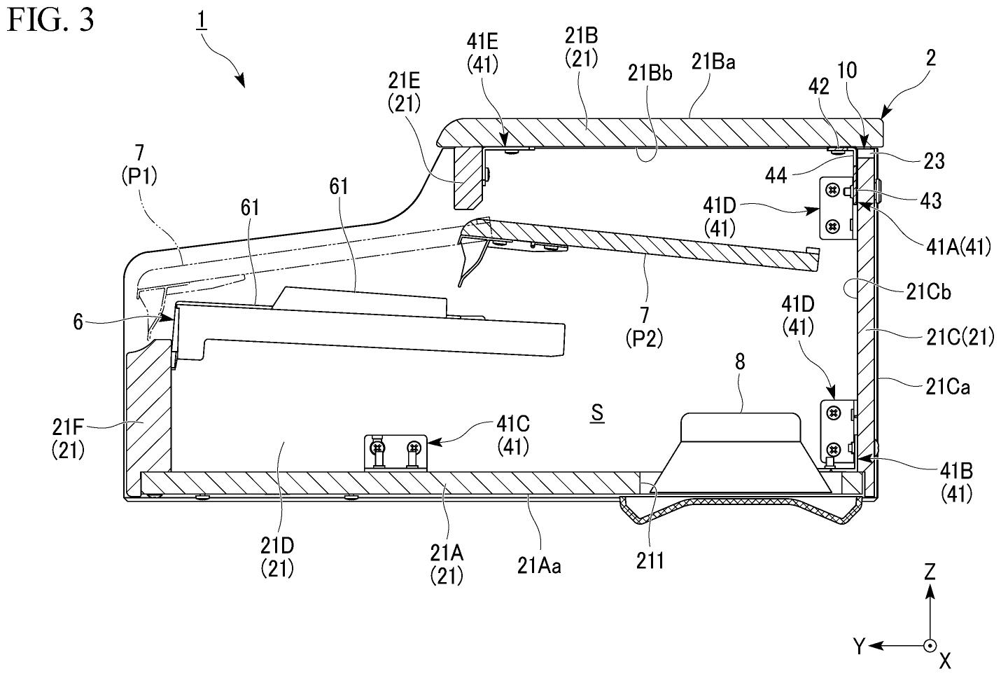

As shown in FIG. 3, the bottom board 21A is arranged so that the thickness direction thereof is oriented in the up-down direction, and constitutes the bottom face 21Aa of the housing 2. The keyboard part 6 is arranged in a portion above and on the front side of the bottom board 21A.

The top board 21B (roof) is positioned above the bottom board 21A with a gap therebetween so that the thickness direction thereof extends along the up-down direction. The bottom board 21B covers only a rear-side portion of the bottom board 21A from above, and is arranged so as not to cover the keyboard part 6. The top board 21B constitutes the top face 21Ba of the housing 2.

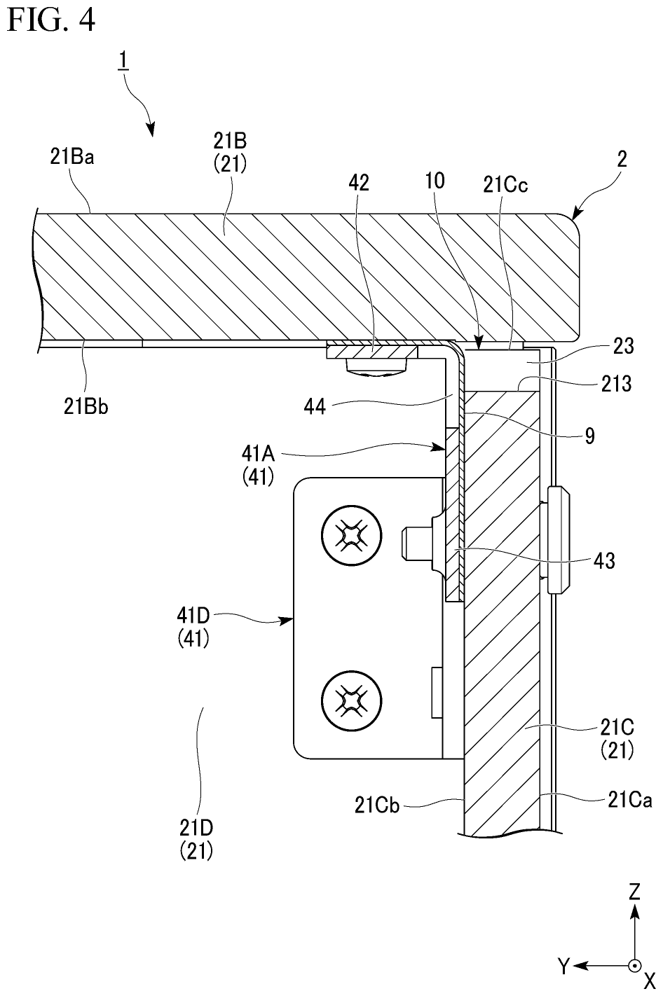

The back board 21C (back frame) is arranged at the rear ends of the bottom board 21A and the top board 21B so that the thickness direction thereof extends along the front-rear direction. The back board 21C constitutes the back face 21Ca of the housing 2. In the present embodiment, the back board 21C is arranged to cover the rear-side end face of the bottom board 21A. Also, as shown in FIG. 4, an upper end face 21Cc of the back board 21C (hereinafter, referred to as upper end face 21Cc) is covered by the top board 21B. The rear end of the top board 21B overhangs rearward beyond the back board 21C.

As shown in FIG. 3, the top board 21E is arranged on the lower side of the front end portion of the top board 21B so that the thickness direction thereof extends along the front-rear direction. The top board 21E is arranged between the top board 21B and the keyboard lid 7 in the up-down direction. The top board 21E covers the gap between the top board 21B and the keyboard lid 7 from the front side.

The key slip 21F is arranged on the front end side of the bottom board 21A and the keyboard part 6 so that the thickness direction thereof extends in the front-rear direction, and extends upward from the bottom board 21A to the keyboard part 6. The key slip 21F covers the gap between the bottom board 21B and the keyboard part 6 from the front side.

As shown in FIG. 1 to FIG. 3, the side boards 21D are arranged at both end parts of the housing 2 in the left-right direction so that the thickness direction thereof extends along the left-right direction. The side boards 21D constitute side faces 21Da of the housing 2. The side boards 21D cover the left and right ends of the bottom board 21A, the back board 21C, the front top board 21E, and the key slip 21F. The upper end faces of the side boards 21D are covered by the top board 21B.

As shown in FIG. 3, the keyboard lid 7 is movable between a covering position P1 covering the upper side of the keyboard part 6 and a retracted position P2 not covering the keyboard part 6 (the upper side of the keyboard part 6). In the present embodiment, the keyboard lid 7 is positioned between the keyboard part 6 and the front top board 21E in the up-down direction, and moves in the front-rear direction between the covering position P1 and the retracted position P2. The keyboard lid 7 arranged at the retracted position P2 is arranged in the internal space S of the housing 2 and is covered from above by the top board 21B.

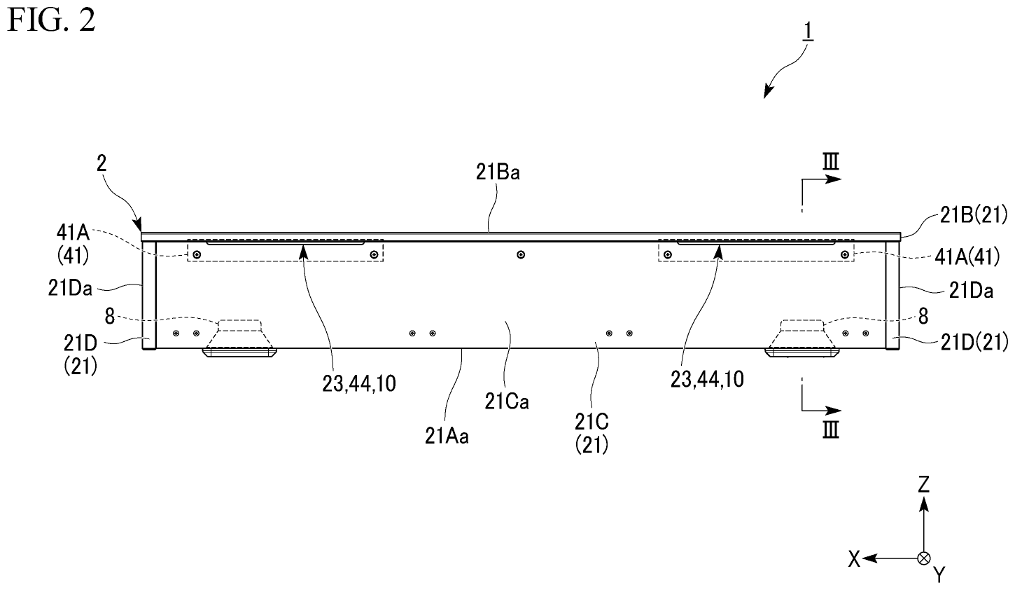

The speakers 8 are arranged in the interior of the housing 2 and output sound according to input signals. The input signals input to the speakers 8 may be signals corresponding to the operation performed on the keyboard part 6, for example. Each speaker 8 is arranged to radiate sound both to the outside of the housing 2 and to the internal space S of the housing 2. Through holes 211 are formed in the bottom board 21A of the housing 2. The speaker 8 is arranged in or near the through hole 211 of the bottom board 21A so that the sound generated by the speaker 8 is radiated downward from the housing 2 through the through hole 211. With the speaker 8 arranged in such a manner, the sound generated by the speaker 8 also propagates above the speaker 8 within the internal space S of the housing 2. As shown in FIG. 1 and FIG. 2, two speakers 8 are arranged at positions spaced apart from each other in the left-right direction.

As shown in FIG. 2 to FIG. 4 and FIG. 6, the housing 2 is formed with an opening 23 (first opening) penetrating the housing 2. The opening 23 of the housing 2 allows the internal space S of the housing 2 and the space outside the housing 2 to communicate with each other. In the present embodiment, the opening 23 of the housing 2 is formed between the top board 21B and the back board 21C. Therefore, the opening 23 of the housing 2 faces the rear of the housing 2.

A recessed part 213 is formed in the flat upper end face 21Cc of the back board 21C. The opening 23 of the housing 2 is configured by bringing the upper end face 21Cc, in which the recessed part 213 is formed, into surface contact with the lower face (inner face 21Bb described later) of the top board 21B. The opening 23 (recessed portion 213) of the housing 2 is formed in a horizontally elongated shape with a dimension in the left-right direction sufficiently longer than the dimension thereof in the up-down direction.

In the present embodiment, two openings 23 of the housing 2 are arranged at positions spaced apart from each other in the left-right direction. The positions of the two openings 23 in the left-right direction correspond to the positions of the two speakers 8 spaced apart in the left-right direction.

Reinforcing members 41 are members that reinforce the housing 2. The reinforcing members 41 in the present embodiment are joining members 41 that constitute the housing 2 and join two adjacent members 21 to each other (hereinafter, the reinforcing members 41 may be referred to as joining members 41). As shown in FIG. 3, the joining members 41 include a first joining member 41A, a second joining member 41B, a third joining member 41C, a fourth joining member 41D, and a fifth joining member 41E. The first joining member 41A joins the top board 21B and the back board 21C together. The second joining member 41B joins the bottom board 21A and the back board 21C together. The third joining member 41C joins the bottom board 21A and the side board 21D together. The fourth joining member 41D joins the back board 21C and the side board 21D together. The fifth joining member 41E joins the top board 21B and the front top board 21E together.

As shown in FIG. 4 to FIG. 7, the first joining member 41A is formed in an L shape having a first flat plate part 42 and a second flat plate part 43. The first flat plate part 42 and the second flat plate part 43 are orthogonal to each other. In the first joining member 41A, the first flat plate part 42 and the second flat plate part 43 are each formed in a belt plate shape. In other words, the first flat plate part 42 and the second flat plate part 43 are each formed in a belt shape, a plate shape, or a rectangular shape. The widthwise end of the first flat plate part 42 and the widthwise end of the second flat plate part 43 are connected.

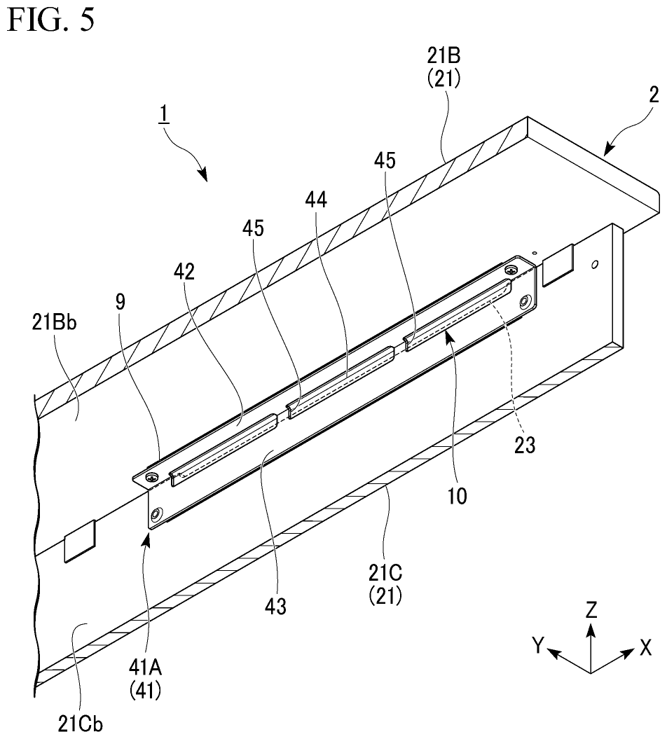

As shown in FIG. 4 and FIG. 5, the first flat plate part 42 is fixed to the top board 21B (first member) and the second flat plate part 43 is fixed to the back board 21C (second member) whereby the first joining member 41A joints the top board 21B and the back board 21C together. In the present embodiment, the first joining member 41A is fixed inside the housing 2 so as to be highly invisible from the outside of the housing 2. Specifically, the first flat plate part 42 overlaps the inner face 21Bb of the top board 21B facing the inside (lower side) of the housing 2, and is fixed to the inner face 21Bb of the top board 21B by means of screw fastening or the like. The second flat plate part 43 overlaps the inner face 21Cb of the back board 21C facing the inside (front side) of the housing 2, and is fixed to the inner face 21Bb of the top board 21B by means of screw fastening or the like.

The second to fifth joining members 41B to 41E (see FIG. 3) are L-shaped as with the first joining member 41A. As with the first joining member 41A, each of the second to fifth joining members 41B to 41E is fixed to the inner faces of two adjacent members 21 of the housing 2 to join these two members 21 together.

The first joining member 41A has a sound emitting opening 44 (second opening). The sound emitting opening 44 is an opening for emitting sound generated in the internal space S of the housing 2 to the outside of the housing 2. In the present embodiment, the sound generated in the internal space S of the housing 2 is the sound radiated into the internal space S of the housing 2 from the speaker 8 (see FIG. 3).

The first joining member 41A is provided in the housing 2 so that the sound emitting opening 44 thereof overlaps the opening 23 of the housing 2 described above. In the present embodiment, the opening 23 of the housing 2 is formed at a corner part formed by the inner face 21Bb of the top board 21B and the inner face 21Cb of the back board 21C when viewed from the inside of the housing 2. Therefore, the sound emitting opening 44 of the first joining member 41A is formed at the corner part formed by the first flat plate part 42 and the second flat plate part 43 corresponding to the corner part formed by the inner face 21Bb and the inner face 21Cb mentioned above. Specifically, the sound emitting opening 44 is formed across the first flat plate part 42 and the second flat plate part 43.

As shown in FIG. 5 to FIG. 7, as with the opening 23 of the housing 2, the sound emitting opening 44 is formed in a horizontally elongated shape with a dimension in the left-right direction sufficiently longer than the dimension thereof in the up-down direction. The dimension of the sound emitting opening 44 in the left-right direction is greater than the dimension of the opening 23 of the housing 2 in the left-right direction. Moreover, the dimension of the sound emitting opening 44 in the up-down direction is greater than the dimension of the opening 23 of the housing 2 in the up-down direction. That is to say, the opening area of the sound emitting opening 44 is greater than the opening area of the opening 23 of the housing 2. It should be noted that the opening area of the sound emitting opening 44 may be the same as the opening area of the opening 23 of the housing 2.

The first joining member 41A is provided with a reinforcing column 45 that divides the sound emitting opening 44 into a plurality of openings. In the present embodiment, the reinforcing column 45 is provided so as to divide the sound emitting opening 44, which is elongated in the left-right direction, into a plurality (three in FIG. 5 to FIG. 7) of openings in the left-right direction.

As shown in FIG. 4 and FIG. 5, the sound emitting opening 44 of the first joining member 41A and the opening 23 of the housing 2 overlapping the sound emitting opening 44 form a sound emitting opening 10 that emits the sound generated in the interior of the housing 2 to the outside of the housing 2. Since the sound emitting opening 10 of the present embodiment faces (is provided) toward the rear of the housing 2, the sound generated in the interior of the housing 2 is emitted to the rear of the housing 2 through the sound emitting opening 10.

As shown in FIG. 4 to FIG. 6, the musical instrument 1 of the present embodiment further includes a cover member 9. The cover member 9 is formed in a sheet shape or a plate shape, and covers the opening 23 of the housing 2 from the inside of the housing 2. The cover member 9 is formed so that the interior of the housing 2 is highly invisible from the outside of the housing 2 through the opening 23 of the housing 2. Moreover, the cover member 9 is configured to allow transmission of sound therethrough. The cover member 9 may be, for example, a non-woven fabric or a mesh member. Also, the cover member 9 may be configured by forming a large number of through holes in a plate material, for example. It is preferable that the mesh size of the mesh member and the size of the through holes formed in the plate material be much smaller than, for example, the sound emitting opening 44 of the reinforcing member 41 and the opening 23 of the housing 2.

The cover member 9 of the present embodiment is sandwiched between the inner face the housing 2 and the first joining member 41A. Thus, the cover member 9 can be fixed to the inner face of the housing 2 only by fixing the first joining member 41A to the inner face of the housing 2. It should be noted that the cover member 9 may be arranged, for example, so as to sandwich the first joining member 41A between itself and the inner face of the housing 2. That is to say, the cover member 9 may be attached to the face of the first joining member 41A facing the internal space S side of the housing 2.

Next, here is described an example of a method of forming a sound emitting opening for a musical instrument (a method of forming a musical instrument, a method of manufacturing a musical instrument) for forming the sound emitting opening 10 that enables sound emission to the outside of the housing 2 in the musical instrument 1 of the present embodiment.

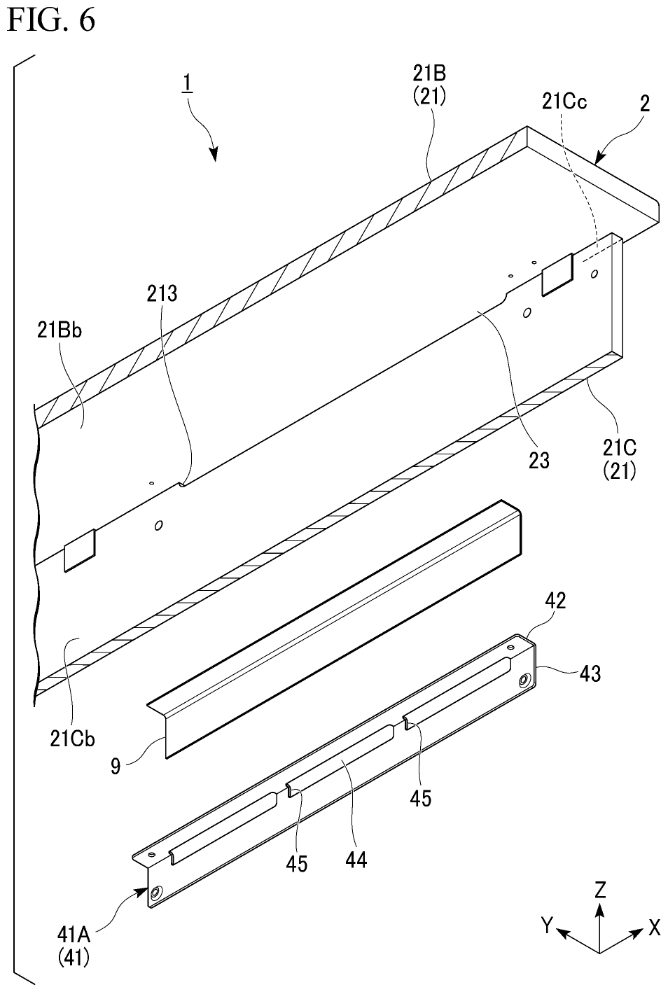

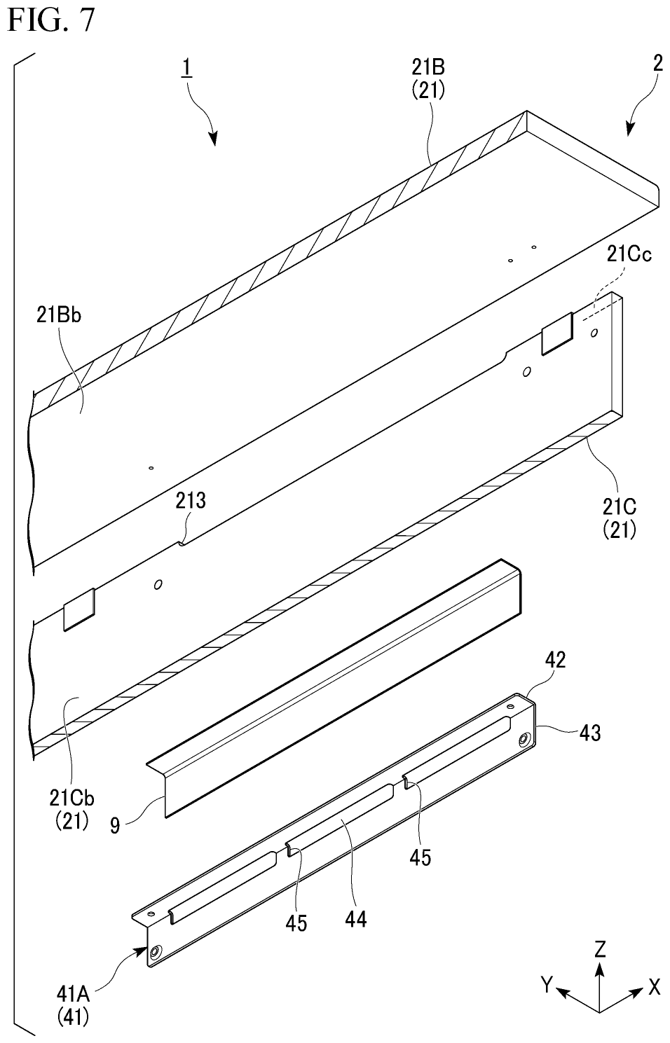

In order to form the sound emitting opening 44 in the musical instrument 1, first, as shown in FIG. 6 and FIG. 7, the opening 23 penetrating through the housing 2 is formed in the housing 2. In the present embodiment, a recessed part 213 is formed in the flat upper end face 21Cc of the back board 21C. Further, the upper end face 21Cc of the back board 21C is brought into surface contact with the inner face 21Bb of the top board 21B to thereby form the opening 23 of the housing 2.

Moreover, the first joining member 41A (reinforcing member 41) having the sound emitting opening 44 is prepared. For example, a metallic plate material is formed into a belt plate shape (belt, plate, or rectangular), and punching or the like is performed on the plate material to form the sound emitting opening 44, whereby the first joining member 41A is manufactured. Moreover, the L-shaped first joining member 41A may be manufactured by bending the plate material.

After having formed the opening 23 in the housing 2 and preparing the first joining member 41A, the first joining member 41A is provided in the housing 2 as shown in FIG. 5. Specifically, the first flat plate part 42 of the first joining member 41A is overlapped with and fixed to the inner face 21Bb of the top board 21B of the housing 2. Moreover, the second flat plate part 43 of the first joining member 41A is overlapped with and fixed to the inner face 21Cb of the back board 21C of the housing 2. At this time, the opening 23 of the housing 2 is overlapped with the sound emitting opening 44 of the first joining member 41A. As a result, the sound emitting opening 10 is formed by the opening 23 of the housing 2 and the sound emitting opening 44 of the first joining member 41A, which overlap each other. This completes the method of forming a sound emitting opening for a musical instrument.

As described above, in the musical instrument 1 and the method of forming a sound emitting opening for a musical instrument of the present embodiment, the sound emitting opening 44 of the first joining member 41A (reinforcing member 41) that reinforces the housing 2 of the musical instrument 1 overlaps the opening 23 of the housing 2. For this reason, in the musical instrument 1 of the present embodiment, the sound generated in the interior of the housing 2 can be emitted to the outside of the housing 2 through the sound emitting opening 44 of the first joining member 41A and the opening 23 of the housing 2 overlapping therewith. That is to say, the first joining member 41A does not hinder sound emission from the interior of the housing 2 to the outside. As a result, effective utilization of the sound generated in the interior of the housing 2 enables the performer and the audience to enjoy rich and powerful performance sounds.

Moreover, in the musical instrument 1 of the present embodiment, the opening area of the sound emitting opening 44 of the first joining member 41A (reinforcing member 41) is greater than the opening area of the opening 23 of the housing 2. As a result, even if the attachment position of the first joining member 41A with respect to the housing 2 is shifted, it is possible to suppress reduction in the opening area of the sound emitting opening 10, which is formed by the sound emitting opening 44 of the first joining member 41A and the opening 23 of the housing 2. That is to say, it is possible to ensure the opening area of the sound emitting opening 10.

Moreover, in the musical instrument 1 of the present embodiment, the sound emitting opening 44 is formed in the first joining member 41A that joins the two members 21 (top board 21B and back board 21C) of the housing 2 together. As a result, the first joining member 41A can be utilized as a member for emitting sound to the outside of the housing 2.

Moreover, in the musical instrument 1 of the present embodiment, the first joining member 41A is formed in an L shape having the first flat plate part 42 fixed to the inner face 21Bb of the top board 21B (first member) and the second flat plate part 43 fixed to the inner face 21Cb of the back board 21C (second member). As a result, even if the opening 23 of the housing 2 is formed in a portion spanning across the top board 21B and the back board 21C of the housing 2, by using the single L-shaped first joining member 41A having the sound emitting opening 44 formed at the position corresponding to the opening 23, it is possible to avoid complication of the joining structure of the members 21 of the housing 2. Specifically, by using the first joining member 41A having the sound emitting opening 44, it is possible to reduce the number of joining members 41 to be used and simplify the joining structure, compared to the case of arranging an L-shaped joining member having no sound emitting opening 44 therein so as to avoid the opening 23 of the housing 2. Furthermore, the first joining member 41A having the sound emitting opening 44 is provided over the entire region of the inner face of the housing 2 corresponding to the opening 23 of the housing 2. As a result, it is possible to even more firmly join the two members 21 of the housing 2 together.

Moreover, in the musical instrument 1 of the present embodiment, the sound emitting opening 44 is formed at the corner part formed by the first flat plate part 42 and the second flat plate part 43 of the first joining member 41A. As a result, the sound emitting opening 44 of the first joining member 41A can be easily overlapped with the opening 23 of the housing 2 formed at the corner part between the inner face 21Bb of the top board 21B (first member) and the inner face 21Cb of the back board 21C (second member).

Moreover, in the case where the sound emitting opening 44 is formed at the corner part formed by the first flat plate part 42 and the second flat plate part 43 of the first joining member 41A, it is possible to well maintain the exterior design of the housing 2 (musical instrument 1). This point will be described below.

It is possible to make the opening 23 of the housing 2 formed at the corner part of the housing 2 highly invisible from the outside of the housing 2, depending on the relative arrangement of the top board 21B and the back board 21C that constitute the corner part of the housing 2. Specifically, as shown in FIG. 4, the upper side of the opening 23 of the housing 2 formed between the top board 21B and the upper end of the back board 21C is covered by the rear end part of the top board 21B overhanging rearward beyond the back board 21C. That is to say, the portion overhanging rearward beyond the top board 21B functions as a canopy that covers from above the opening 23 of the housing 2 formed between the top board 21B and the back board 21C. As a result, the opening 23 of the housing 2 becomes highly invisible from the upper face 21Ba side of the housing 2. Therefore, it is possible to make the sound emitting opening 44 of the joining member 41 corresponding to the opening 23 of the housing 2 formed between the top board 21B and the back board 21C of the housing 2 also highly invisible from the outside of the housing 2. As a result, it is possible to well maintain the exterior design of the housing 2 (musical instrument 1).

Furthermore, the musical instrument 1 of the present embodiment includes the cover member 9 that allows sound transmission therethrough and covers the opening 23 of the housing 2 from the inside of the housing 2. As a result, the cover member 9 does not hinder sound emission from the interior of the housing 2 to the outside of the housing 2, and the cover member 9 can suppress the visibility of the interior of the housing 2 from the outside of the housing 2 through the opening 23 of the housing 2 and the sound emitting opening 44 of the first joining member 41A.

Moreover, in the musical instrument 1 of the present embodiment, the first joining member 41A has the reinforcing column 45 that divides the sound emitting opening 44 into a plurality of openings. As a result, the reinforcing column 45 enables to ensure the rigidity of the first joining member 41A even if the size of the sound emitting opening 44 is large.

The present disclosure has been described in detail above, however, the present disclosure is not limited to the above embodiment, and various modifications may be made without departing from the scope of the present disclosure.

In the musical instrument of the present disclosure, the opening 23 of the housing 2 penetrating through the housing 2 is not limited to being formed between the top board 21B and the back board 21C. The opening 23 may be formed between other two adjacent members 21 of the housing 2, such as any one of the following: between the bottom board 21A and the back board 21C; between the bottom board 21A and the side board 21D; between the back board 21C and the side board 21D; and between the top board 21B and the front top board 21E. In such a case, the sound emitting opening 44 overlapping the opening 23 of the housing 2 may be formed in the second to fifth joining members 41B to 41E, for example. That is to say, the sound emitting opening 10 composed of the opening 23 of the housing 2 and the sound emitting opening 44 of the joining member 41 may be oriented forward or sideways of the housing 2.

In the musical instrument of the present disclosure, for example, the sound emitting opening 44 may be formed in each of the first and second flat plate parts 42 and 43 of the joining member 41 formed in an L shape. In such a case, even if the opening 23 of the housing 2 is formed in each of the two adjacent members 21 (first member and second member) of the housing 2, it is possible to match the sound emitting openings 44 of the first and second flat plate parts 42 and 43 respectively with the openings 23, and form two sound emitting openings 10. That is to say, the openings 23 of the housing 2 formed respectively in the two adjacent members 21 of the housing 2 can be matched, using a single L-shaped joining member 41. As a result, it is possible to avoid complication of the joining structure of the members 21 of the housing 2.

In the musical instrument of the present disclosure, the reinforcing member 41 having the sound emitting opening 44 formed therein is not limited to the joining member 41 that joins the members 21 of the housing 2 together. The reinforcing member 41 may be a member that reinforces one member 21 of the housing 2, for example. In such a case, the reinforcing member 41 may be provided in the housing 2 so that the sound emitting opening 44 thereof overlaps the opening 23 formed in the one member 21 of the housing 2.

In the musical instrument of the present disclosure, the sound source arranged in the interior of the housing 2 is not limited to the speaker 8 that generates sound by being electrically driven as in the above embodiment. The sound source may be, for example, a sound source that generates sound by being mechanically driven. Examples of such a sound source include a structure including strings and action mechanisms in which the strings are struck to generate sound as can be seen in an acoustic piano.

The musical instrument of the present disclosure is not limited to a keyboard instrument having a keyboard part, but can also be applied to any musical instrument that includes a housing having an internal space therein and a reinforcing member that reinforces the housing.

According to the present disclosure, effective utilization of the sound generated in the interior of the housing of a musical instrument enables the performer and the audience to enjoy rich and powerful performance sounds.

The present disclosure may be applied to a musical instrument, a method of forming a sound emitting opening for a musical instrument, and a reinforcing member.

What is claimed is:

1. A musical instrument comprising:
a housing including a first opening; and
a reinforcing member that reinforces the housing and including a second opening overlapping with the first opening, wherein the second opening allows emission of sound generated in an interior of the housing to outside of the housing therethrough.

2. The musical instrument according to claim 1, wherein an area of the second opening is equal to or greater than an area of the first opening.

3. The musical instrument according to claim 1, wherein:
the housing comprises a plurality of members including a first member and a second member disposed adjacent to each other, and
the reinforcing member joins the first member and the second member to each other.

4. The musical instrument according to claim 3, wherein:
the reinforcing member is L-shaped and comprises a first flat plate part and a second flat plate part angled with respect to each other,
the first flat plate part is attached to the first member, and
the second flat plate part is attached to the second member.

5. The musical instrument according to claim 4, wherein the second opening is disposed at a corner part where the first flat plate part and the second flat plate part meet.

6. The musical instrument according to claim 1, further comprising a cover member configured to allow transmission of the sound while covering the first opening from inside of the housing.

7. The musical instrument according to claim 1, wherein the reinforcing member comprises at least one reinforcing column that divides the second opening into a plurality of openings.

8. The musical instrument according to claim 1, further comprising a speaker disposed inside of the housing.

9. A method of forming a sound emitting opening for a musical instrument, the method comprising:
providing a housing that includes a first opening;
providing a reinforcing member including a second opening for reinforcing the housing; and
attaching the reinforcing member to the housing so that the second opening overlaps with the first opening to allow emission of sound generated in an interior of the housing to outside of the housing.

10. A reinforcing member for a musical instrument including a housing with a first opening, the reinforcing member comprising:
a member including a second opening and that reinforces the housing,
wherein the second opening is disposed overlapping with the first opening to permit emission of sound generated in an interior of the housing to outside of the housing.

11. The reinforcing member according to claim 10, wherein:
the housing comprises a plurality of members including a first member and a second member disposed adjacent to each other, and
the member of the reinforcing member joins the first member and the second member to each other.

12. The reinforcing member according to claim 10, wherein the member of the reinforcing member is strip-shaped or plate-shaped.

13. The reinforcing member according to claim 11, wherein:
the member of the reinforcing member is L-shaped and comprises a first flat plate part and a second flat plate part angled with respect to each other,
the first flat plate part is attached to the first member, and
the second flat plate part is attached to the second member.

14. The reinforcing member according to claim 13, wherein the second opening is disposed at a corner part where the first flat plate part and the second flat plate part meet.

15. The reinforcing member according to claim 10, further comprising at least one reinforcing column that divides the second opening into a plurality of openings.
